(19) United States
(12) Patent Application Publication
(10) Pub. No.: US 2005/0154570 A1
(43) Pub. Date: Jul. 14, 2005

(54) Radio frequency identification simulator

(75) Inventor: Patrick Joseph Sweeney, Philoment, VA (US)

Correspondence Address: JUSTIN GRAY, 12003 WALNUT BRANCH RD., RESTON, VA, 20194, US

(73) Assignee: ALYSIS INTERACTIVE CORPORATION, San Francisco, CA (US)

(21) Appl. No.: 10/707,820

(22) Filed: Jan. 14, 2004

(51) Int. Cl. G06F 17/50

(52) U.S. Cl. 703/13

(57) ABSTRACT

A method and system for simulating radio frequency identification (RFID) systems. The system determines RFID system configurations and components that meet user constraints to facilitate planning for RFID system deployment. The simulator updates a database on the basis user input and radio frequency interrogator data from deployed systems.

### BACKGROUND OF INVENTION

Radio frequency identification (RFID) systems allow for the identification of objects at a distance and out of line of sight. They are comprised of transponders called radio frequency (RF) tags and RF interrogators (also called readers). The tags are usually smaller and less expensive than interrogators, and are commonly attached to objects such as product packages in stores. When an interrogator comes within range of an RF tag, it may provide power to the tag via a querying signal, or the RF tag may use stored power from a battery or capacitor to send a radio frequency signal to be read by the RFID interrogator.

RF tags may consist of single integrated circuits, circuits and antennas, or may incorporate more complex capabilities such as computation, data storage, and sensing means. Some categories of RFID tags include the following: passive tags that acquire power via the electromagnetic field emitted by the interrogator, semi-passive tags that respond similarly, but also use on-board stored power for other functions, active tags that use their own stored power to respond to an interrogator“s signal, inductively coupled tags that operate at low frequencies and short distances via a coil antenna, single or dipole antenna-equipped tags that operate at higher frequencies and longer distances, read-write tags that can alter data stored upon them, full-duplex or half duplex tags, collision arbitration tags that may be read in groups, or non-collision tags that must be read individually.

RFID systems present a number of advantages over other object marking and tracking systems. A radio frequency interrogator may be able to read a tag when it is not in line of sight from the interrogator, when the tag is dirty, or when a container encloses the tag. RFID systems may identify objects at greater distances than optical systems, may store information into read/write tags, may operate unattended, and may read tags hidden from visual inspection for security purposes. These advantages make RFID systems useful for tracking objects. They are being adopted for use in retail stores, airports, warehouses, postal facilities, and many other locations. RFID systems will likely be more widely adopted as the price of tags and interrogators decreases.

As organizations strive to adopt RFID systems for tracking objects, they face challenges imposed by the nature of the objects they handle and the environments in which those objects are processed. Radio frequency signals are reflected, refracted, or absorbed by many building, packaging, or object materials. Moving people, vehicles, weather and ambient electromagnetic radiation can also effect the performance of RFID systems. Compounding the situation is a growing diversity of choices among RFID systems and components with dimensions such as cost, range, and power consumption. Often companies must purchase and evaluate systems through trial and error, a time-consuming and costly process. Radio frequency design and testing software, RF site surveys and prototype systems can assist the process, but there still exists a need for a complete simulator that models the problem space with sufficient realism to deliver accurate specifications for appropriate RFID systems and their configurations prior to their adoption and deployment. Furthermore, a need exists for such a system that manages a database of RFID system components and specifications so that it is able to meet price and performance constraints imposed by RFID system designers.

U.S. Pat. No. 5,339,087 discloses a wavefront simulator that emulates plane wave propagation from multiple transmitting antennas to determine the configuration of antennas or to cancel the energy of an interfering transmitter. The apparatus differs from this invention in that it consists of electronic hardware to be used within a physical world environment to gather information for a site survey or diagnosis or optimization. The apparatus does not actively manage a database of RFID system component specifications, does not perform constraint analysis, and does not simulate RFID system use. The apparatus requires that it be used within an environment before producing data.

U.S. Pat. No. 6,665,849 discloses a method and apparatus for simulating physical fields. The apparatus differs from this invention in that it addresses issues of integrated circuit interface. It simulates high frequency effects for the design of on-chip interconnect structures. The apparatus does not actively manage a database of RFID system component specifications, does not perform constraint analysis, and does not simulate RFID system use. The apparatus requires that it be used within an environment before producing data.

U.S. Pat. No. 5,999,861 discloses a method and apparatus for computer-aided design (CAD) of different-sized RF modular hybrid circuits. The apparatus differs from this invention in scale and capability. It designs circuits, rather than configurations of circuits. The apparatus does not populate a database of RFID system component specifications, does not perform constraint analysis based on parameters such as cost, object velocity, or environmental materials, and does not simulate RFID system use.

U.S. Pat. No. 6,389,372 discloses a system and method for bootstrapping a collaborative filtering system. The method does populate a database based on input of users. The method differs from this invention in that it does not perform constraint analysis based on parameters such as cost, object velocity, or environmental materials, and does not simulate RFID system use.

U.S. Pat. No. 6,092,049 discloses a method and apparatus for efficiently recommending items using automated collaborative filtering and feature-guided automated collaborative filtering. The method does populate a database based on input of users. The method differs from this invention in that it does not does not perform constraint analysis based on parameters such as cost, object velocity, or environmental materials, and does not simulate RFID system use.

U.S. Pat. Application No. 2003/0182027 A1 discloses a system and method for simulating an input to a telematics system. It is intended to simulate components interacting with a software module to facilitate the development of the software. The system does simulate data processing components of a vehicle, but differs from this invention in other regards. The system does not populate a database based on input of users. The system does not provide information regarding the placement of radio frequency transceivers with respect to each other, does not simulate radio wave propagation, and does not simulate RFID system use.

### SUMMARY OF INVENTION

This invention relates to a method and system for simulating radio frequency identification (RFID) systems. By simulating RFID systems, the invention allows its users to impose constraints and then determine configurations and components of RFID systems that meet those constraints before deployment. Once an RFID system is deployed, its radio frequency (RF) interrogator or interrogators may validate or correct the database of information used by the simulator. The system comprises a database, a user interface, a logical system simulator, a radio wave propagation simulator, and an external data network access means. The database may contain specifications for RF tags, RF interrogators, RF characteristics of materials, and other data useful for simulation of RFID systems. The user interface provides a means for users of the system to enter constraints regarding hypothetical RFID systems that they would like to deploy, such as cost, physical environment, throughput, and minimum read rate. The logical system simulator then queries the database and may employ the radio wave propagation simulator to determine which RFID systems will meet the user“s constraints and the configurations of those systems. New information entered into the database through a user“s interaction with the system is transferred via the external data network access means for processing and potential storage within the databases of other instances of the system.

One embodiment of the system consists entirely of software operating on a personal computer, mobile computing platform, mobile communications device or other means of performing computation.

Another embodiment of the invention uses electronic hardware such as an RF transceiver to facilitate dynamic use within a physical environment in interaction with simulated or actual RFID system components.

Another embodiment of the invention makes the determination of signal strength at particular locations by means of simulation of radio wave propagation simulation. Inputs include materials or material characteristics such as permeability, permittivity, magnetic or electric loss tangents, homogeneity, conductivity, and resistance. Other inputs include geometry of tagged objects with respect to RF tags, containers, obstacles and interrogators. Methods of simulation employing these inputs and outputs are documented in engineering literature and may employ the finite-difference time domain method, the finite element method, numerical electromagnetic code, electromagnetic surface patch, NEWAIR or combinations of these methods. In this embodiment, the invention simulates propagation of radio frequency energy to predict dispersion, losses, mode conversion, and radiation. Through these means, the invention provides an output of signal strength at particular locations and other quantities useful for RFID system simulation.

The foregoing general description and the following detailed description are exemplary and explanatory only and do not restrict the claims directed to the invention. The accompanying drawings, which are incorporated in and constitute a part of this specification, illustrate some embodiments of the invention and together with the description, serve to explain the principles of the invention but not limit the claims or concept of the invention.

### BRIEF DESCRIPTION OF DRAWINGS

FIG. 1 is a diagram illustrating the overall structure of an embodiment of the system.

FIG. 2 is a flow chart illustrating the steps through which an embodiment of the system simulates RFID systems.

FIG. 3 is a screen shot of the graphical user interface of an embodiment of the system.

### DETAILED DESCRIPTION

The following detailed description of preferred embodiments of this invention and the attached figures are intended to provide a clear description of the invention without limiting its scope.

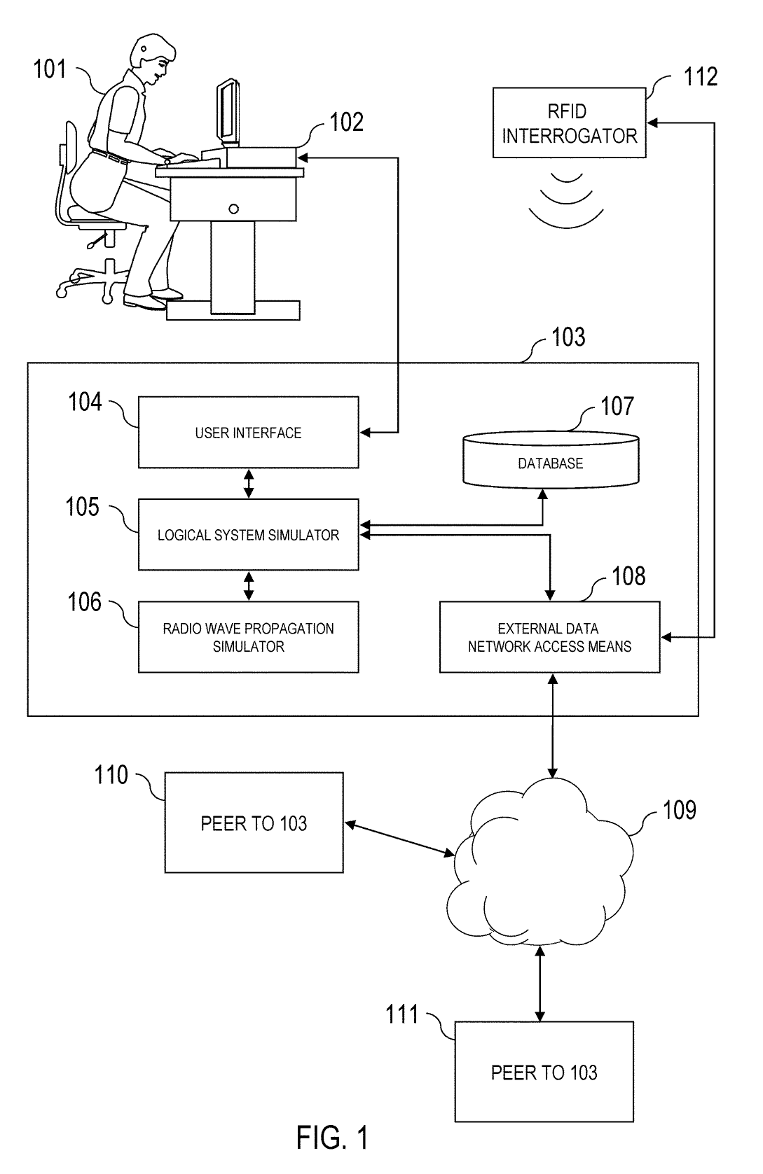

FIG. 1 is a diagram illustrating the overall structure of an embodiment of the system. A user of the system 101 accesses a computer with graphical display 102. The system 103 operates primarily upon the hardware of computer 102 and consists of several major components. The user interface 104 allows for the user 101 to input information and view or otherwise output results. The logical system simulator 105 uses the information gathered from the user interface 104, radio wave propagation simulator 106, database 107, external data network access means 108, and RFID interrogator 112. The external data network 109 is accessible by peers of the system 110 and 111. Information from RFID interrogator 112 confirms or invalidates information presented by other sources based on the RF tags that it reads within the actual environment.

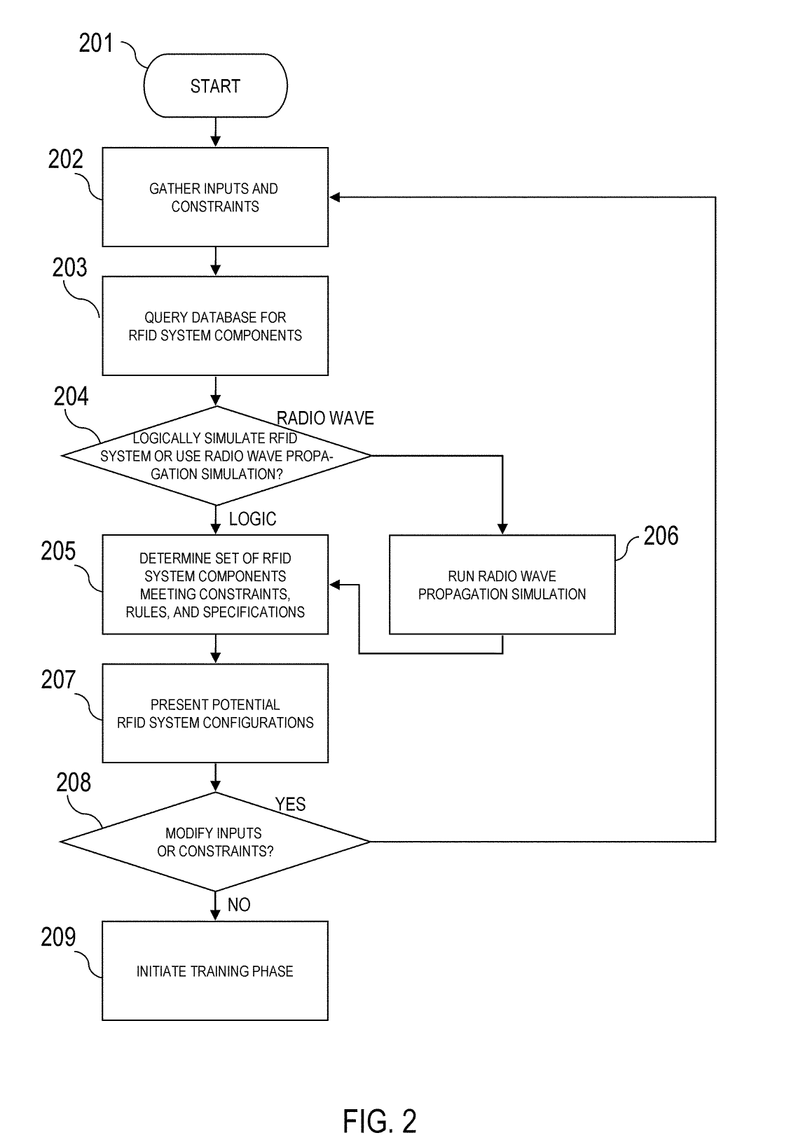

FIG. 2 is a flow chart illustrating the steps through which an embodiment of the system simulates RFID systems. Once execution initiates at 201, the system presents a user interface for acquiring the inputs and constraints that define the problem to be solved. By way of example only, important inputs to the system may include the dimensions of a doorway in which an interrogation field is to be established, the size of items to be tracked, shape of items to be tracked, number of items to be tracked per pallet or container, and the speed with which items move through the interrogation field. Constraints on the system may include boundaries for standard inputs such as a maximum width or height for an interrogation field, or RF tag cost, or desired manufacturers for components. Once these inputs and constraints are acquired, the system of this example embodiment queries the database in 203 to acquire the set of system components that may meet the constraints imposed by the user. Then the determination is made in 204 whether to use logical rules to simulate RFID systems and determine a set of solutions or to also use more computationally intensive radio wave propagation simulation. If radio wave propagation simulation is required, for instance for a container of individually tagged objects, then the simulation is run in 206 to determine field strength results before proceeding to 205. Otherwise, logical rules are applied in 205 to determine the set of RFID system components satisfying the rules, constraints and specifications and their configurations. In 207, the system presents the available configurations to the user for output or modification. The user makes the determination to modify or use the output in 208, directing execution back to 202 or on to 209. When execution proceeds to 209, the system enters a training phase, whereupon the system integrates new data of sufficient quality with the database for use by peers of the system. The training process operates either upon information gathered directly from an RF interrogator connected to the system 112, or on the basis of new information entered by users and peers or both.

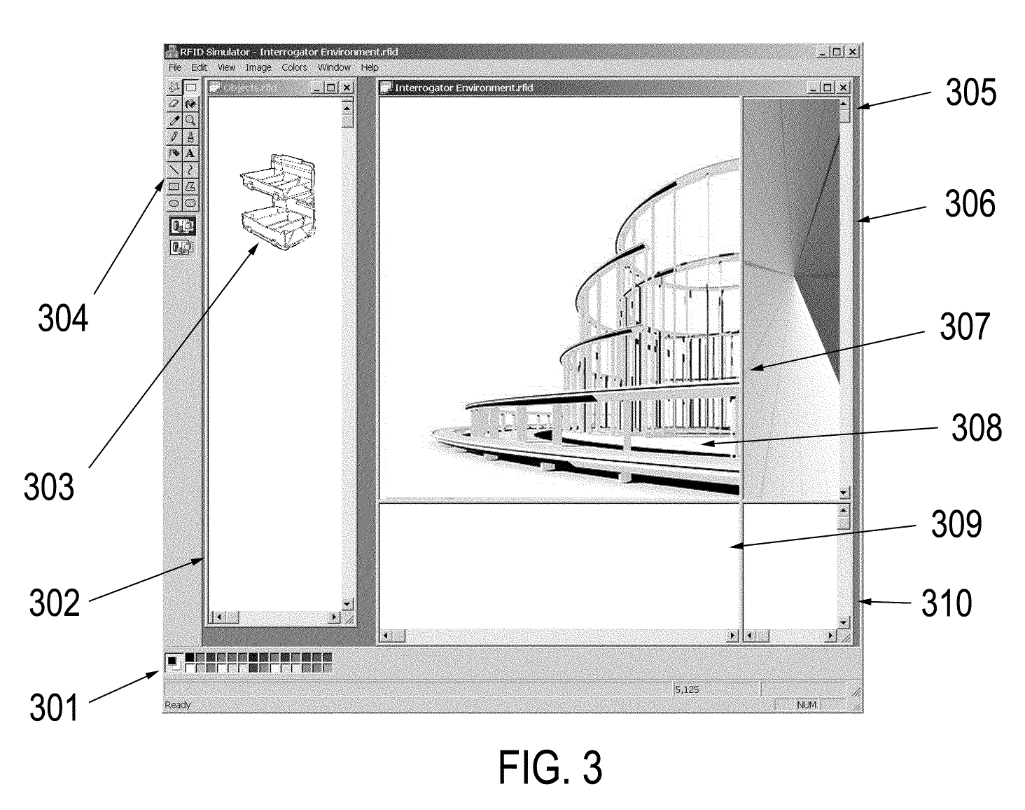

FIG. 3 is a screen shot of the graphical user interface of an embodiment of the system. Materials palette 301 is used to apply materials to objects within the object palette window 302. Objects such as 303 are displayed in editable wire frame form or rendered. Object editing palette 304 is used to build objects, edit them or import or export them. Objects from 302 are placed within interrogator environment 305, which consists of 4 separate panes. Pane 306 displays simulated electromagnetic fields about RF tags and interrogators. Pane 307 displays a cross sectional or wire frame or rendered display 308 of the architectural environment of the RFID system. Pane 309 is a palette of RF tags that may be dragged into 307. Pane 310 is a palette of RF interrogators that may also be dragged into 307.

1. A system for simulating radio frequency identification systems comprising:
a database containing radio frequency identification system component specifications and other information useful for simulating such systems;
a user interface allowing for input and output;
a radio wave propagation simulator;
an external data network access means;
and a logical system simulator that uses input from the user interface, the database, the radio wave propagation simulator, and the external data network access means to determine configurations and components of radio frequency identification systems meeting requirements entered via the user interface and to add and remove records from the database.

2. A system according to claim 1 wherein the database is updated on the basis of information acquired from other similar systems via the external data network access means.

3. A system according to claim 1 wherein the database is updated on the basis of information acquired from the radio frequency interrogator.

4. A system according to claim 1 wherein the user interface acquires and presents information primarily via text.

5. A system according to claim 1 wherein the user interface acquires and presents information primarily through graphics.

6. A system according to claim 1 further comprising one or more radio frequency interrogators to provide physical-world input and output for the logical system simulator;
A method for simulating radio frequency identification systems comprising the steps of:
a querying a database containing radio frequency identification system component specifications and other information useful for simulating such systems;
acquiring constraints from a user interface allowing for input and output;
sending information to and receiving information from a radio wave propagation simulator;
sending information to and receiving information from an external data network access means;
and processing the resulting data through a logical system simulator to determine configurations and components of radio frequency identification systems meeting requirements entered via the user interface and to add and remove records from the database.
